(19) United States
(12) Patent Application Publication
(10) Pub. No.: US 2007/0263120 A1
(43) Pub. Date: Nov. 15, 2007

(54) Electronic device for adjusting light intensity and light color temperature of a photoflash

(76) Inventor: Chin-Hsin Ho, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/498,890

(22) Filed: Aug. 4, 2006

(30) Foreign Application Priority Data
Apr. 28, 2006 (TW) 95207348

(51) Int. Cl. H04N 5/222

(52) U.S. Cl. 348/371

(57) ABSTRACT

An electronic device for adjusting light intensity and light color temperature of a photoflash includes: a casing, a photoflash window set, and an adjusting element. The casing has a first opening, a second opening, and a photoflash window receiving space communicated with the second opening. The photoflash window set is slidably disposed on the casing and received in the photoflash window receiving space, and the photoflash window set has a first photoflash window and a second photoflash window. The adjusting element is disposed on the casing for exposing the first opening, and the adjusting element is jointed with the photoflash window set. Thereby, the first photoflash window or the second photoflash window is selectively exposed through the second opening by controlling the adjusting element for light beams that are projected from the photoflash to produce different light intensity and light color temperature.

### BACKGROUND OF THE INVENTION

1. Field of The Invention

The present invention relates to an electronic device with a photoflash, and particularly relates to electronic device for adjusting light intensity and light color temperature of a photoflash.

2. Description of the Related Art

There are many methods for people to commemorate an occasion. One common way is by taking pictures, because any occasion such as travel, a celebration, an event, or any good time that deserves to be commemorated can be recorded via a camera. Moreover, it is convenient for users to transmit image data from the camera to an electronic device such as a computer for modifying the image data. In addition, the price of a digital camera has become increasingly cheaper, so the number of people using digital cameras increases day by day. Meanwhile, digital cameras are increasing light, thin, and small.

In order to make up for insufficient light, users usually use a photoflash. Generally, cameras have a small photoflash installed therein. Hence, it is still convenient for users to carry the camera around with them.

Hence, when the light is insufficient in dark environment, the user needs to use the photoflash. However, the light intensity of the photoflash is always the same. In other words, no matter whether the environment is dark or light, or how far away the object is, the light intensity of the photoflash is constant. Because the light intensity of the photoflash is constant, the brightness and the contrast for taking a picture is not good as is desired.

Moreover, in different light source environments the photoflash needs to adjust the color temperature. However, the photoflash of the camera in the prior art only has one kind of color temperature. Hence, in the prior art the color temperature cannot be adjusted according to different light source environments.

### SUMMARY OF THE INVENTION

The present invention provides an electronic device for adjusting light intensity and light color temperature of a photoflash. The electronic device produces photoflash windows with different colors via double injection molding technology. Each photoflash window has a strip set or a fog face with different densities formed on a surface thereof. Hence, the electronic device can adjust the light intensity and the light color temperature relating to the photoflash according to different environments. In other words, in the present invention a strip set or a fog face with different densities is formed on different photoflash windows for producing different light intensities. For example, when the light is sufficient and the user needs to take a picture close to an image target, the picture will produce a picture that is either overexposed due to intensity light. Hence, the user can switch to the photoflash window with the strip set or the fog face that has different densities formed on the surface of the photoflash window. Furthermore, the camera can use different photoflash windows with different colors to produce different color temperatures. For example, in an inside room with soft light (the color temperature is about 3000 k˜3500 k), the user can switch the photoflash window and use the photoflash window with lemon yellow.

A first aspect of the present invention is an electronic device for adjusting light intensity and light color temperature of a photoflash, comprising: a casing, a photoflash window set and an adjusting element. The casing has a first opening, a second opening, and a photoflash window receiving space communicated with the second opening. The photoflash window set is slidably disposed on the casing and received in the photoflash window receiving space, wherein the photoflash window set has a first photoflash window and a second photoflash window. The adjusting element is disposed on the casing for exposing the first opening, wherein the adjusting element is jointed with the photoflash window set. The first photoflash window or the second photoflash window can be selectively exposed through the second opening by controlling the adjusting element for light beams that are projected from the photoflash to produce different light intensity and light color temperature.

A second aspect of the present invention is an electronic device for adjusting light intensity and light color temperature of a photoflash, comprising: a casing and a photoflash window set. The casing has a lateral opening and a photoflash window receiving space communicated with the lateral opening. The photoflash window set has a first photoflash window and a second photoflash window, wherein the first photoflash window and the second photoflash window are selectively passed through the lateral opening and received in the photoflash window receiving space. A user selects the first photoflash window or the second photoflash window to be received in the photoflash window receiving space for light beams that are projected from the photoflash to produce different light intensity and light color temperature.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a perspective, exposed view of an electronic device for adjusting light intensity and light color temperature of a photoflash according to the first embodiment of the present invention;

FIG. 2 is a schematic view of an electronic device in the first service condition according to the first embodiment of the present invention;

FIG. 3 is a schematic view of an electronic device in the second service condition according to the first embodiment of the present invention;

FIG. 4 is a cross-sectional view of a photoflash assembled in a casing according to the first embodiment of the present invention;

FIG. 5 is a perspective, exposed view of an electronic device for adjusting light intensity and light color temperature of a photoflash according to the second embodiment of the present invention;

FIG. 6 is a schematic view of an electronic device in one service condition according to the second embodiment of the present invention; and

FIG. 7 is a cross-sectional view of a photoflash assembled in a casing according to the second embodiment of the present invention.

### DETAILED DESCRIPTION OF PREFERRED BEST MOLDS

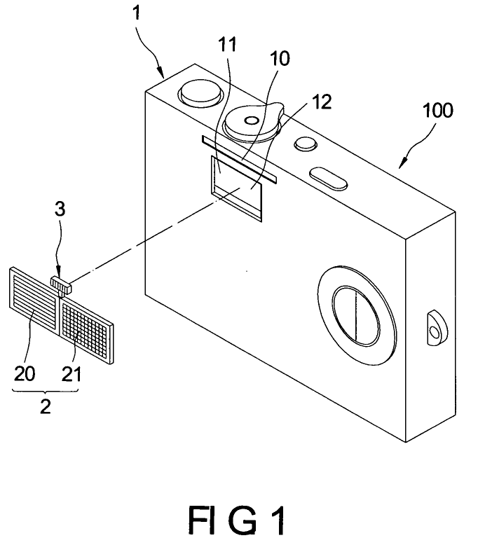

Referring to FIGS. 1-3, the present invention provides an electronic device 100 for adjusting light intensity and light color temperature of a photoflash 200, comprising: a casing 1, a photoflash window set 2 and an adjusting element 3. In addition, the electronic device 100 can be a mechanical camera, a digital camera, a video camera, or any electronic device that uses the photoflash 200.

The casing 1 has a first opening 10, a second opening 11, and a photoflash window receiving space 12 communicated with the second opening 11. The photoflash window set 2 is slidably disposed on the casing 1 and received in the photoflash window receiving space 12. In addition, the photoflash window set 2 has a first photoflash window 20 and a second photoflash window 21. The first photoflash window 20 and the second photoflash window 21 have a strip set or a fog face with different densities formed on a surface thereof, respectively. Moreover, the first photoflash window 20 produces a color different from that of the second photoflash window 21 formed via double injection molding technology for controlling different light color temperatures. Furthermore, both the first photoflash window 20 and the second photoflash window 21 can be made of acrylic material or any other plastic material.

However, the quantity of the above-mentioned photoflash windows does not limit the present invention. More than two photoflash windows of different types can be applied in the present invention. Moreover, the design for the photoflash window (such as the strip set or the fog face with different densities, or different colors) does not limit the present invention. Any number of ways can be used for adjusting light intensity and light color temperature of the photoflash 200 protected in the present invention.

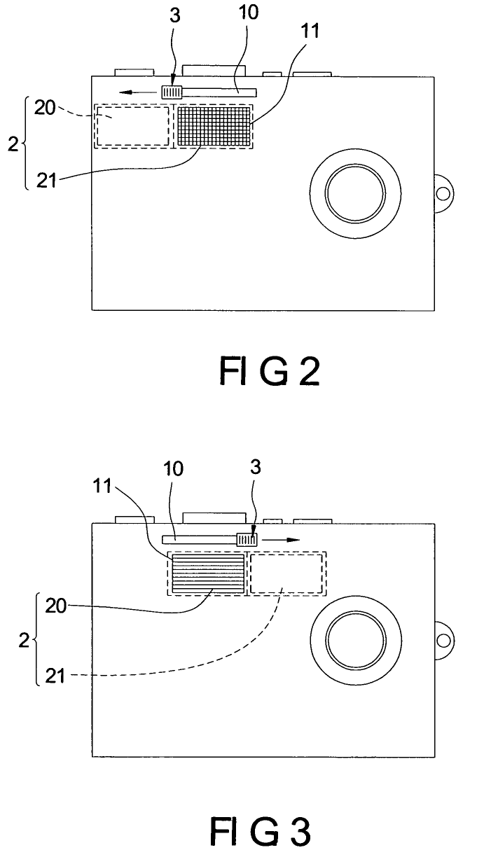

The adjusting element 3 is disposed on the casing 1 for exposing the first opening 10, and the adjusting element 3 is jointed with the first photoflash window 20 and the second photoflash window 21 of the photoflash window set 2. The first photoflash window 20 or the second photoflash window 21 can be selectively exposed through the second opening 11 (as shown in FIG. 2 or FIG. 3) by controlling the adjusting element 3 for light beams that are projected from the photoflash 200 to produce different light intensity and light color temperatures. In addition, the second opening 11 is the same size as the first photoflash window 20 and the second photoflash window 21.

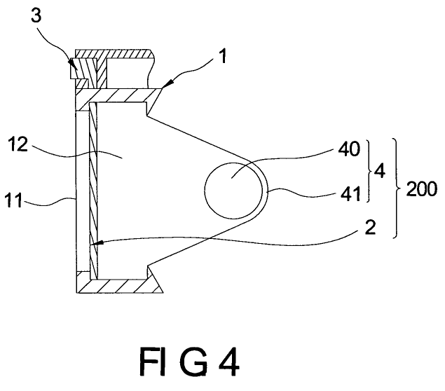

Referring to FIG. 4, the electronic device 100 further comprises a light-emitting module 4 corresponding to the second opening 11, and the light-emitting module 4 has a light source 40 and a reflector 41 for reflecting light beams that are projected from the light source 40. In addition, the light-emitting module 4 can be disposed on the casing 1 by a retaining method or any fixing method.

A user firstly selects the first photoflash window 20 or the second photoflash window 21 to expose the second opening 11 by controlling the adjusting element 3 according to an external environment. Then light beams that are projected from the light-emitting module 4 pass through the first photoflash window 20 for producing a first predetermined light intensity and a first predetermined light color temperature. Alternatively, the light beams that are projected from the light-emitting module 4 pass through the second photoflash window 21 for producing a second predetermined light intensity and a second predetermined light color temperature.

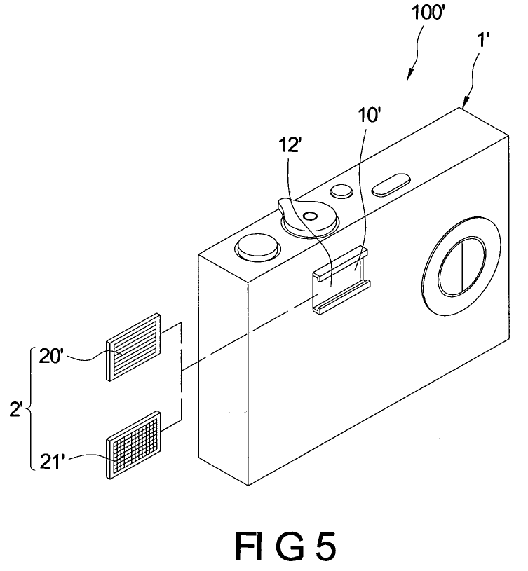

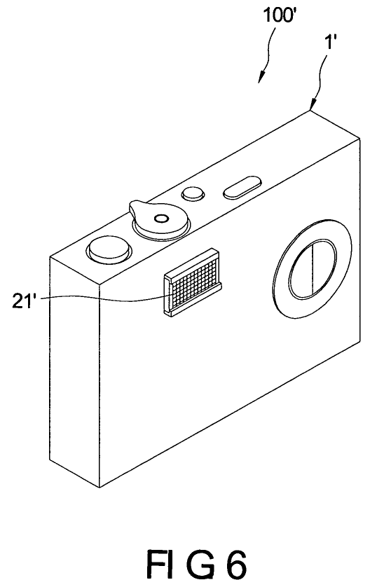

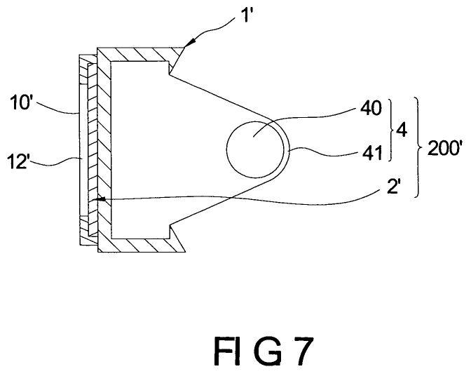

Referring to FIGS. 5-6, the present invention provides an electronic device 100′ for adjusting light intensity and light color temperature of a photoflash 200′, comprising: a casing 1′ and a photoflash window set 2′.

The casing 1′ has a lateral opening 10′ and a photoflash window receiving space 12′ communicated with the lateral opening 10′. The photoflash window set 2′ has a first photoflash window 20′ and a second photoflash window 21′, and the first photoflash window 20′ and the second photoflash window 21′ are selectively passed through the lateral opening 10′ and received in the photoflash window receiving space 12′.

Moreover, as in the first embodiment, the first photoflash window 20′ and the second photoflash window 21′ have a strip set or a fog face with different densities formed on a surface thereof, respectively. The first photoflash window 20′ produces a color different from that of the second photoflash window 21′ formed via double injection molding technology for controlling different light color temperatures. Furthermore, both the first photoflash window 20′ and the second photoflash window 21′ can be made of acrylic material or any other plastic material.

However, the quantity of above-mentioned photoflash window does not limit the present invention. More than two photoflash windows with different types can be applied in the present invention. Moreover, the design for the photoflash window (such as the strip set or the fog face with different densities, or different colors) does not limit the present invention. Any other ways to use the photoflash windows for adjusting light intensity and light color temperature of the photoflash 200′ are protected in the present invention.

A user can select the first photoflash window 20′ or the second photoflash window 21′ to be received in the photoflash window receiving space 12′ for light beams that are projected from the photoflash 200′ to produce different light intensity and light color temperatures (as shown in FIG. 6). In addition, the lateral opening 10′ the same size as that of the first photoflash window 20′ and the second photoflash window 21′.

Referring to FIG. 7, the electronic device 100′ further comprises a light-emitting module 4 corresponding to the lateral opening 10′. The light-emitting module 4 has a light source 40 and a reflector 41 for reflecting light beams that are projected from the light source 40. In addition, the light-emitting module 4 can be disposed on the casing 1′ via a retaining method or any fixing method.

Firstly a user can select the first photoflash window 20′ or the second photoflash window 21′ to be received in the photoflash window receiving space 12′ according to an external environment. Then light beams that are projected from the light-emitting module 4 pass through the first photoflash window 20′ producing a first predetermined light intensity and a first predetermined light color temperature. Alternatively, the light beams that are projected from the light-emitting module 4 pass through the second photoflash window 21′ for producing a second predetermined light intensity and a second predetermined light color temperature.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An electronic device for adjusting light intensity and light color temperature of a photoflash, comprising:
a casing having a first opening, a second opening, and a photoflash window receiving space communicated with the second opening;
a photoflash window set slidably disposed on the casing and received in the photoflash window receiving space, wherein the photoflash window set has a first photoflash window and a second photoflash window; and
an adjusting element disposed on the casing for exposing the first opening, wherein the adjusting element is jointed with the photoflash window set;
whereby, the first photoflash window or the second photoflash window is selectively exposed through the second opening by controlling the adjusting element for light beams that are projected from the photoflash to produce a different light intensity and light color temperature.

2. The electronic device as claimed in claim 1, wherein the electronic device is a mechanical camera, a digital camera, or a video camera.

3. The electronic device as claimed in claim 1, wherein the first photoflash window and the second photoflash window have a strip set or a fog face with different densities formed on a surface thereof, respectively.

4. The electronic device as claimed in claim 1, wherein the first photoflash window has a color different from that of the second photoflash window.

5. The electronic device as claimed in claim 4, wherein both the first photoflash window and the second photoflash window are made of acrylic material.

6. The electronic device as claimed in claim 1, wherein the second opening has a size the same as that of the first photoflash window and the second photoflash window.

7. The electronic device as claimed in claim 1, further comprising a light-emitting module corresponding to the second opening, wherein the light-emitting module is disposed on the casing.

8. The electronic device as claimed in claim 7, wherein the light-emitting module has a light source and a reflector for reflecting light beams that are projected from the light source.

9. The electronic device as claimed in claim 7, wherein the light beams pass through the first photoflash window for producing a first predetermined light intensity and a first predetermined light color temperature.

10. The electronic device as claimed in claim 7, wherein the light beams pass through the second photoflash window for producing a second predetermined light intensity and a second predetermined light color temperature.

11. An electronic device for adjusting light intensity and light color temperature of a photoflash, comprising:
a casing having a lateral opening and a photoflash window receiving space communicated with the lateral opening; and
a photoflash window set having a first photoflash window and a second photoflash window, wherein the first photoflash window and the second photoflash window are selectively passed through the lateral opening and received in the photoflash window receiving space;
whereby, a user selects the first photoflash window or the second photoflash window to be received in the photoflash window receiving space for light beams that are projected from the photoflash to produce different light intensity and light color temperature.

12. The electronic device as claimed in claim 11, wherein the electronic device is a mechanical camera, a digital camera, or a video camera.

13. The electronic device as claimed in claim 11, wherein the first photoflash window and the second photoflash window have a strip set or a fog face with different densities formed on a surface thereof, respectively.

14. The electronic device as claimed in claim 11, wherein the first photoflash window has a color different from that of the second photoflash window.

15. The electronic device as claimed in claim 14, wherein both the first photoflash window and the second photoflash window are made of acrylic material.

16. The electronic device as claimed in claim 11, wherein the lateral opening has a size the same as that of the first photoflash window and the second photoflash window.

17. The electronic device as claimed in claim 11, further comprising a light-emitting module corresponding to the lateral opening, wherein the light-emitting module is disposed on the casing.

18. The electronic device as claimed in claim 17, wherein the light-emitting module has a light source and a reflector for reflecting light beams that are projected from the light source.

19. The electronic device as claimed in claim 17, wherein the light beams pass through the first photoflash window for producing a first predetermined light intensity and a first predetermined light color temperature.

20. The electronic device as claimed in claim 17, wherein the light beams pass through the second photoflash window for producing a second predetermined light intensity and a second predetermined light color temperature.
